(19) United States
(12) Patent Application Publication
(10) Pub. No.: US 2011/0114250 A1
(43) Pub. Date: May 19, 2011

(54) PATCHING HAVING DISCONTINUOUS ENGAGEMENT TO THE TIRE

(75) Inventors: Nathan J. Panning, Simpsonville, SC (US); Cesar Zarak, Simpsonville, SC (US)

(73) Assignee: MICHELIN RECHERCHE ET TECHNIQUE S.A., Granges-Paccot (CH)

(21) Appl. No.: 13/002,219

(22) PCT Filed: Jun. 30, 2008
(86) PCT No.: PCT/US2008/068870

§ 371 Date: Dec. 30, 2010

(51) Int. Cl. B29C 73/10

(52) U.S. Cl. 156/97; 152/367

(57) ABSTRACT

Methods and apparatus for repairing a damaged area of tire include a tire patch, a patch body having a length extending longitudinally, a width extending laterally, and a thickness vertically within the patch; and, a plurality of reinforcements extending in a lengthwise direction of the patch, the plurality of reinforcements being arranged in a spaced-apart, side-by-side arrangement, where at least a portion of the plurality of reinforcements are arranged to laterally alternate between two or more elevations respective of the patch thickness. Methods of applying the patch include attaching the tire patch to a portion of the tire to cover the damaged area of the tire, wherein the arrangement reinforcements alternating along the path is positioned in close relation to the damaged area of the tire.

### BACKGROUND OF THE INVENTION

1. Field of the Invention

This invention relates generally to tire repair patches having reinforcements for application to a portion of a tire, and, more specifically, to tire repair patches having reinforcements located at different elevations within the tire repair patch.

2. Description of the Related Art

Tires are known to be susceptible to becoming damaged. Such damage may occur when a tire encounters road debris, such as nails, glass, and stone, and during tire mounting and dismounting. Damage may also occur on the inside or outside of the tire, or may puncture the tire. Further, the damage may occur along the tread area, or along the sidewalls. In some instances, the damage may not penetrate the tire but weaken a particular area or region of the tire.

When repairing the damaged area of a tire, a patch is commonly used to cover and seal the damaged area. A patch may be made of various types of materials, such as, rubber, or other types of polymeric or elastomeric materials, and may include various reinforcements, such as cords and/or cables. In some applications, the patch may be adhesively affixed to or cured to the tire. Typically, the damaged area is prepped prior to application of the patch. For example, damaged material may be removed, and a surface may be buffed for receiving a patch. The buffed surface may also be cleansed prior to patch application. Subsequent steps may include applying an adhesive or cement prior to installing the patch.

At times, a tire patch may become detached from the tire, resulting in air loss. Formation and propagation of separations may arise between the patch and the damaged area, such as, along the perimeter (i.e., an edge) of the damaged area. For example, the damaged area may include a cross-sectional surface associated with the perimeter of the damaged area, where the surface contains cut reinforcement ends. The arrangement of ends along the surface may form a stress singularity along the surface. This singularity may promote the formation and propagation of a separation between the patch and the tire, which may result in the formation of a crack and ultimately failure of the patch. This mechanism may be amplified when the damaged area is positioned in a high stress or high deflection area of the tire, such as the shoulder or sidewall areas of the tire. What is needed is a tire patch that better resists the formation and propagation of separations along one or more edges of the damaged area.

### SUMMARY OF THE INVENTION

Particular embodiments of the present invention include a tire patch for repairing a vehicle tire. The tire patch includes a patch body being defined by a thickness. The patch also includes a plurality of reinforcements having a length and positioned at least partially within the patch body in a spaced-apart, side-by-side arrangement, where at least a portion of the plurality of reinforcements are arranged to laterally alternate between two or more elevations respective of the patch thickness.

Further embodiments of the present invention also include a tire patch having a tire patch having a patch body being defined by a thickness. The tire patch also includes two or more pairs of adjacently staggered first and second reinforcements extending along the patch body, each first reinforcement having a portion positioned adjacent to a portion of the second reinforcement, the first reinforcement portion and the second reinforcement portion positioned at dissimilar elevations respective of the patch thickness.

Further embodiments of the present invention also include a tire patch having a patch body configured to overlay a damaged area of the tire, the patch body having a thickness, and further defining a two or more generally parallel planes disposed at different elevations respective of the thickness of the patch body at a first location along a length of the patch body. The tire patch also includes a plurality of first and second reinforcements extending in a lengthwise direction of the patch, the first and second reinforcements being arranged in a side-by-side, spaced-apart arrangement, where along a path extending across the patch width at least a portion of the first reinforcement is positioned at any one of two or more planes and at least a portion of the corresponding second reinforcement is positioned at any one of the two or more planes other than the plane in which the at least a portion of the first reinforcement is positioned.

Particular embodiments of the present invention include a method of repairing a damaged area of an associated vehicle tire. The method includes the step providing a tire patch according to any embodiment identified above, and herein. The method also includes the step of attaching the tire patch to a portion of the tire to cover the damaged area of the tire, wherein the portion of laterally alternating reinforcements is positioned in close relation to the damaged area of the tire.

The foregoing and other objects, features, and advantages of the invention will be apparent from the following more detailed descriptions of particular embodiments of the invention, as illustrated in the accompanying drawings wherein like reference numbers represent like part of the invention.

### BRIEF DESCRIPTION OF THE DRAWINGS

FIG. 1 is a partial cross sectional view of a tire having a tire patch applied to a region of the tire according to an embodiment of the invention.

FIG. 2 is a top sectional view of the tire repair patch of FIG. 1, showing a plurality of reinforcements adjacently positioned within the tire patch in accordance with the embodiments of the present invention.

FIG. 3 is a side sectional view of a tire repair patch of FIG. 1, showing undulations in the reinforcements in close association with a damaged area of a tire, according to an embodiment of the invention.

FIG. 4 is a sectional end view of the tire repair patch shown in FIG. 1.

FIG. 5 is a side sectional view of another embodiment of the tire patch shown in close association with a damaged area of a tire, in accordance with embodiments of present invention.

FIG. 6 is a side sectional view of yet another embodiment of the tire patch shown in close association with a damaged area of a tire, in accordance with embodiments of present invention.

FIG. 7 is a sectional end view of the tire repair patch shown in FIG. 6.

FIG. 8 is a side sectional view of still another embodiment of the tire patch showing reinforcements lying at different elevations, in close association with a damaged area of a tire, in accordance with embodiments of present invention.

FIG. 9 is a sectional end view of the tire repair patch shown in FIG. 8.

FIG. 10 is a sectional end view showing cords having different diameters received within the patch body, in accordance with an embodiment of the invention.

FIG. 11 is a sectional end view showing cords positioned at three elevations within the patch body, in accordance with an embodiment of the invention.

FIG. 12 is a sectional end view showing cords received with in the patch body at multiple elevations, in accordance with an embodiment of the invention.

### DETAILED DESCRIPTION OF PARTICULAR EMBODIMENTS

Particular embodiments of the present invention provide methods and devices for repairing the damaged area 30 of a tire 10. The devices include a tire patch 15 having a plurality of reinforcements 20 layered within a tire patch body 21. The plurality of reinforcements 20 are arranged such that at least adjacent portions of particular reinforcements 20 extend between different elevations within the patch body 21. In certain embodiments of the present invention, individual reinforcements 20 are circuitously routed within the patch body 21 between different elevations.

Tires 10 are known to be constructed from reinforcements 20, such as cords or cables, arranged and cured within elastomeric material, such as natural or synthetic rubber. Accordingly, a tire is susceptible to becoming damaged, such as at various locations along the tread 11, shoulders 13, and sidewalls 14. Damage may be caused by the penetration of an object, such as a nail, glass, or stone. Damage may also result from the tire becoming scratch, abraded, or lacerated from road debris, curbs, accidents, or tire mounting and dismounting procedures. Damage may also comprise a tire defect or result from manufacturing complications. The damaged area 30 may include damage to the tire reinforcements, and/or the elastomeric material, each of which may compromise the integrity of the tire until repaired. The damaged area 30 is generally any area of the tire that one desires to repair or to add reinforcement.

Particular embodiments of the invention include methods of repairing a damaged area of an associated vehicle tire, the method including the step of providing a tire patch. Any embodiment of a tire patch may be provided in accordance with the present invention. Particular embodiments provide a tire patch having a patch body, the patch body being defined by a thickness. Generally, the patch and patch body may be arbitrarily shaped or comprise any general shape, including a polygon, a circle, or an ellipse. The patch may be shaped and sized to substantially cover or overlay the damaged area. In particular embodiments, the patch is generally planar, at least prior to application to the tire.

The patch of such methods includes a plurality of reinforcements extending at least partially within the patch body. Reinforcements have a length and extend in a lengthwise direction, which may be linear or curvilinear. Reinforcements may comprise any reinforcement known for use, or useable, within a tire, which includes cables, such as steel cables, and textile cords. In particular embodiments, the plurality of reinforcements are positioned at least partially within the patch body and may be arranged in a spaced-apart, side-by-side arrangement. In particular embodiments, the reinforcements generally extend in a lengthwise direction to form an array of reinforcements, where rubber is disposed between adjacently positioned reinforcements. In further embodiments, at least a portion of the plurality of reinforcements are arranged to laterally alternate (i.e., relative to the lengthwise direction of the reinforcements, or in the side-by-side direction) between two or more elevations respective of the patch thickness. Further, the portion of laterally alternating reinforcements may form a path of alternating reinforcements extending across a patch width, where the reinforcements alternate between two or more elevations respective of the patch thickness. The path may be linear, curvilinear, or non-linear. Further, the path (or, laterally alternating arrangement) may include adjacent, 1×1, alternating reinforcements, or it may include non-staggered or non-alternating pairs of reinforcements interposed within the alternating arrangement, where such arrangement may be, for example, 1×2, 1×3, or 2×2. The patch of such methods provides a variable-elevation or multi-elevation reinforcement arrangement. Accordingly, at least a portion of one or more reinforcements extends within one elevation or plane, and at least a portion of one or more adjacent reinforcements extends within a second elevation or plane, where the at least a portion of each such reinforcement is positioned along the patch or patch body so to extend at different distances from a patch bottom surface or a damaged area relative to other such reinforcements.

In other embodiments of such methods, the step of providing a tire patch includes providing a tire patch having a patch body being defined by a thickness. The patch of such embodiments also includes two or more pairs of adjacently staggered first and second reinforcements extending along the patch body, each first reinforcement having a portion positioned adjacent to a portion of the second reinforcement, the first reinforcement portion and the second reinforcement portion positioned at dissimilar elevations respective of the patch thickness.

In other embodiments of such methods, the step of providing a tire patch includes providing a tire patch having a patch body configured to overlay a damaged area of the tire, the patch body having a thickness, and further defining a two or more generally parallel planes disposed at different elevations respective of the thickness of the patch body at a first location along a length of the patch body. The patch according to such embodiments also includes a plurality of first and second reinforcements extending in a lengthwise direction of the patch, the first and second reinforcements being arranged in a side-by-side, spaced-apart arrangement, where along a path extending across the patch width at least a portion of the first reinforcement is positioned at any one of two or more planes and at least a portion of the corresponding second reinforcement is positioned at any one of the two or more planes other than the plane in which the at least a portion of the first reinforcement is positioned.

Particular embodiments of such methods also include the step of attaching the tire patch to a portion of the tire to substantially cover the damaged area of the tire, wherein the portion of laterally alternating reinforcements is positioned in close relation to the damaged area of the tire. The patch may be attached by use of an adhesive, uncured rubber, or any other known or useful means, each of which may form a portion of the patch. Further, portions of the patch having the multi-elevation reinforcement arrangement are generally placed close to the damaged area in an attempt to reduce any force or stiffness singularity located along the damaged area. In particular embodiments, the multi-elevation reinforcement arrangement is placed substantially adjacent to an edge of the damaged area of the tire. In particular embodiments, the edge includes at least one tire reinforcement ending. Particular embodiments of the step of attaching include arranging the first and second reinforcements in a generally radial direction of a radial tire (i.e., the direction extending between the tire beads).

The methods described herein utilize a patch to repair a damaged tire area. Exemplary embodiments of the patches for use in practicing such methods are discussed in further detail below.

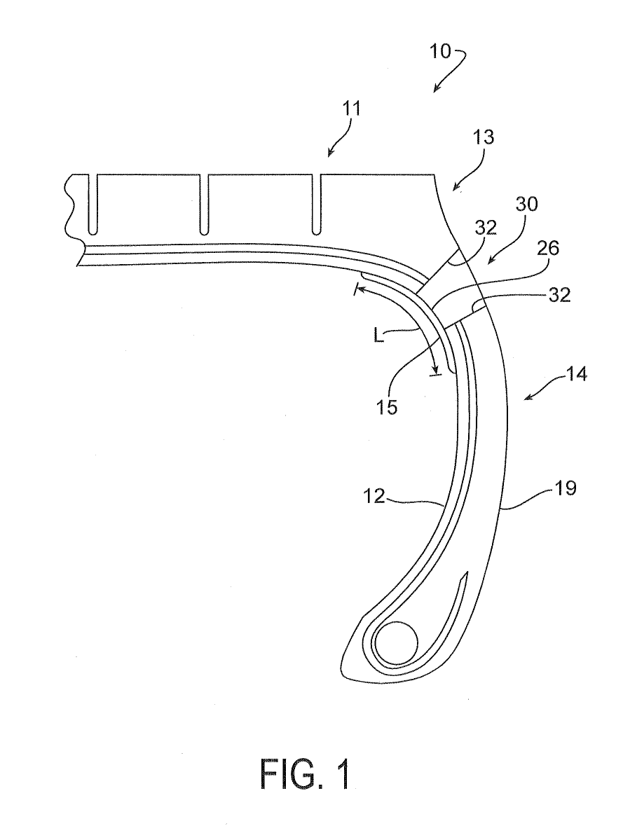

Tire patches 15 of the present invention are generally applied to the tire 10, so to cover or span the damaged area 30 for the purpose of sealing and reinforcing the tire 10. Tire patch 15 generally comprises a plurality of reinforcements 20 extending a patch body 21. In particular embodiments, reinforcements 20 extend between ends 28, 29 of the tire patch 15. Patch 15 may form of any shape, including, for example, any polygon, circle, or ellipse. As shown in the FIGURES in particular embodiments, patch 15 comprises a rectangular shape. Accordingly, it is contemplated that a patch 15 having a length may also have a width, where the length equals the width. FIG. 1 shows a cross sectional view of a tire 10 having a tire patch 15 applied to an interior surface 12 of the tire, adjacent a damaged portion 30. Usually such repairs are affected on an interior surface 12 of the tire 10, although it is contemplated that patches 15 may be applied to any other surface of the tire, including an exterior surface 19.

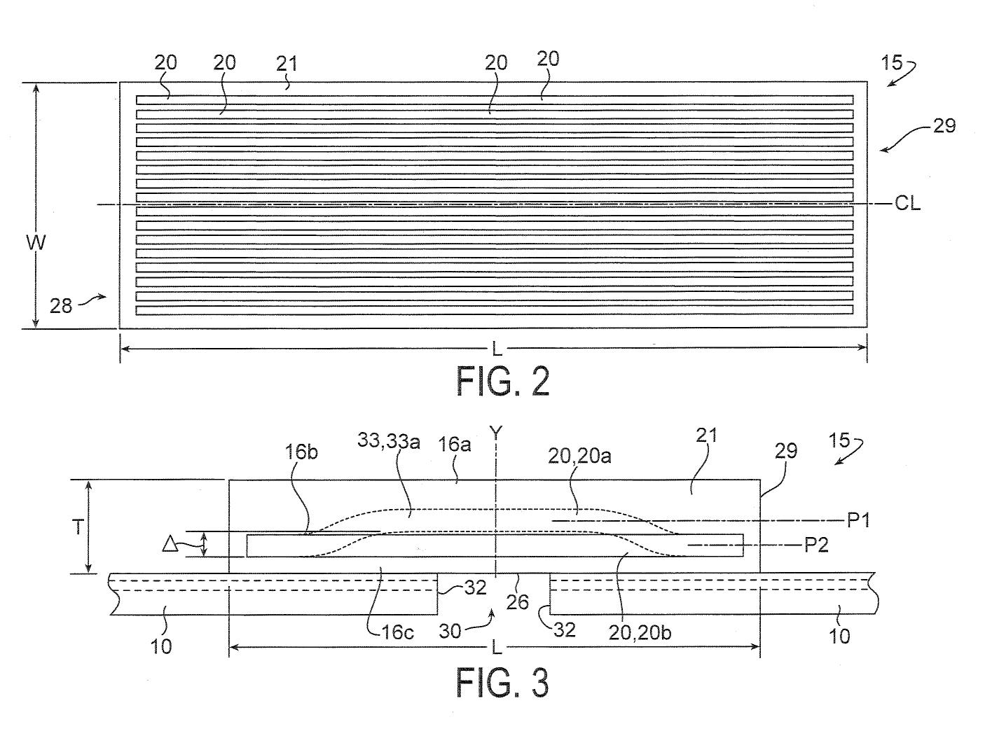

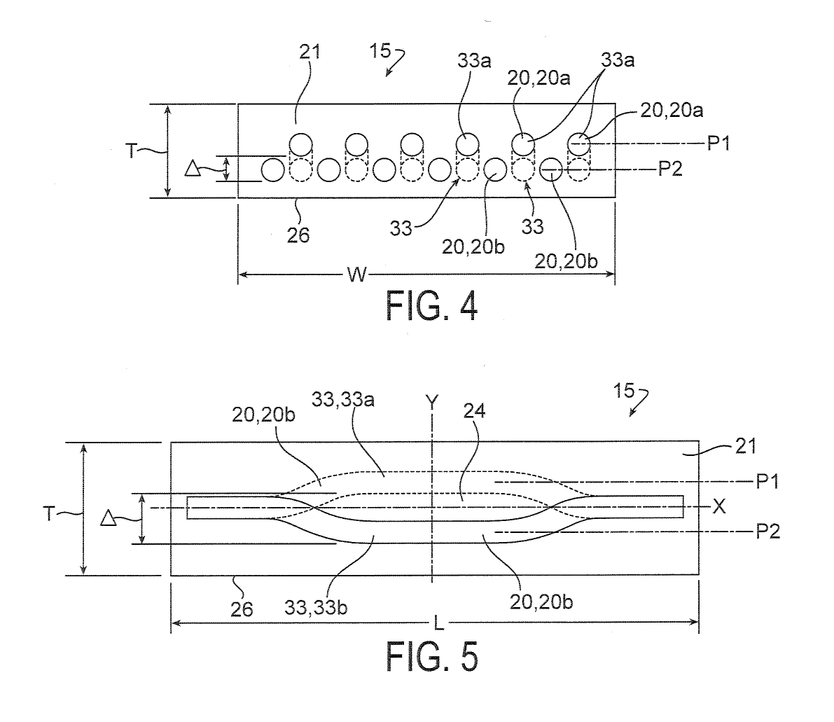

With regard to FIG. 2, a top sectional view of patch 15 is shown in a particular embodiment. Patch 15 generally includes a body 21 containing a plurality (two or more) of reinforcements 20. Patch body 21 may form any arbitrary shape or geometrical shape, such as a polygon, a circle, or an ellipse, each of which have a length, width, and thickness, where, as suggested above, the length may equal the width. Reinforcements 20 may comprise one or more layers of reinforcements 20 arranged at different elevations within a thickness T of the patch 15. A reinforcement layer may be arranged in manner relative to any other reinforcement layer. It is further contemplated that reinforcements 20 may be interwoven with other reinforcements 20 within patch 15. In particular embodiments, such as shown in FIG. 2 by way of example, reinforcements 20 are arranged in a spaced-apart, side-by-side (i.e., adjacent) arrangement along body 21. A side-by-side arrangement does not connote an adjacently alternating arrangement, as adjacent reinforcements may not be positioned at different respective elevations. In accordance with this invention, the arrangement includes a lateral (i.e., in the side-by-side direction) arrangement or path extending across a portion of the patch, where a plurality of reinforcements 20 are arranged to alternate between two or more elevations respective of the patch thickness. An alternating arrangement of reinforcements may form adjacently alternating reinforcements, or non-adjacent alternating arrangement, where non-staggered reinforcements are interposed between adjacent pairs of alternating (i.e., staggered or offset) reinforcements. By way of example, such path may extend across width W at the lengthwise position associated with axis Y in FIG. 3, along the path associated with the cross-section shown in FIG. 4, or along any other extending across patch 15 at any angled relative to a length or width of patch 15. In various embodiments, the path containing a multi-elevation (i.e., alternating) arrangement of reinforcements may be linear or curvilinear.

With general reference to FIGS. 2-12, various embodiments of patches 15 are shown, where each embodiment includes a plurality of reinforcements 20 having portions positioned at different elevations (i.e., different planes) within the tire patch 15 and arranged in an alternating or staggered arrangement, so to provide a plurality of reinforcements that extend at different distances: (1) relative to other reinforcements 20; (2) from a patch bottom surface 26; and/or (3) from a damaged area 30. The difference in elevations between alternating reinforcements 20, such as between a pair of staggered reinforcements (namely, a first reinforcement 20a and a second reinforcement 20b), is generally referred to as an offset distance Δ in the FIGURES. An alternating arrangement of reinforcements generally includes a plurality of staggered pair of reinforcements 20a, 20b, which may be quantified as offset distance Δ. The offset distance Δ more generally represents the alternating distance between reinforcements 20 in the various embodiments. It is contemplated that the offset distance Δ for any reinforcement 20 may be upwards of 5 millimeters (mm). In particular embodiments, offset distance Δ may be between 2 and 3 mm. Offsets greater than 5 mm may also be used, such as, for example, when a patch 15 is to be used for larger tires. It is also contemplated that the offset Δ between alternating reinforcements 20 may be equal to the sum of 1 or more reinforcement diameters. In more specific embodiments, offset Δ may be equal to the sum of 1-4 reinforcement diameters. Although any size reinforcement may be used within a patch 15, in particular embodiments, reinforcements 20 having a diameter approximately between 0.7 and 1.2 mm may be used.

Reinforcement 20 may also have an undulation 33 extending along its length, which is identified in the FIGURES as 33a or 33b. A third reinforcement 20c, or any additional reinforcement 20, may be included in the multi-elevation (i.e., alternating) arrangement. This variable-elevation or multi-elevation arrangement of reinforcements 20 may also be referred to as a multi-planar arrangement, where at least some of the reinforcements 20, or portions thereof, extend in different planes, each of which extend longitudinally and laterally at a particular height or thickness within patch thickness T. The variable-elevation arrangement assists in alleviating the discontinuity associated with a damaged area 30 and/or edge 32 of the tire, which suppresses creation and propagation of separations between the patch 15 and the damaged tire portion 30.

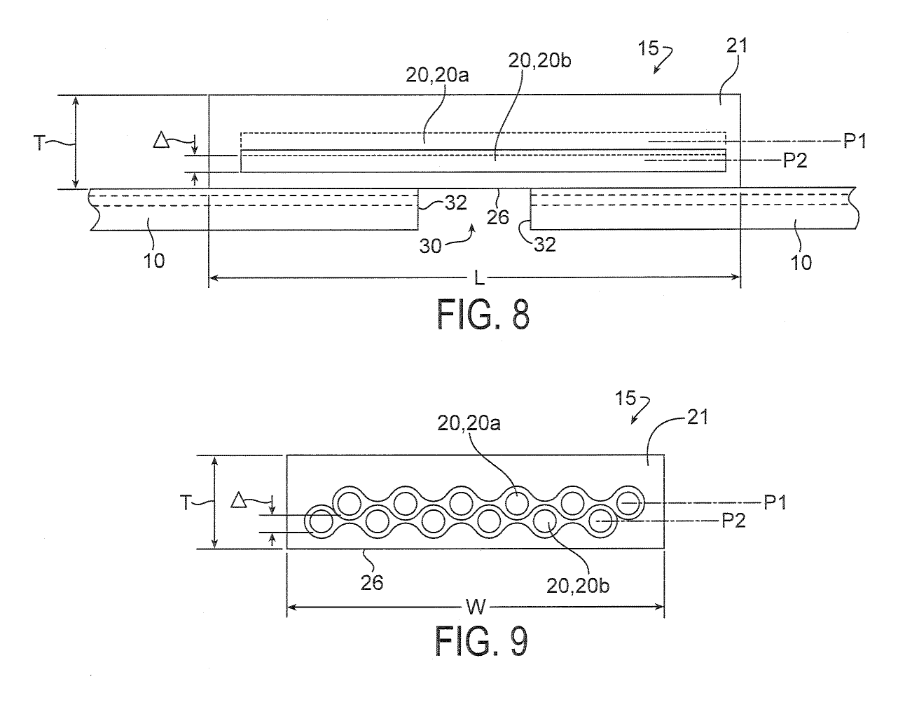

Accordingly, reinforcements 20 may be arranged at different elevations in various manners to achieve a variable-elevation reinforcement arrangement. For example, a variable-elevation arrangement may be achieved by circuitously arranging portions of reinforcements 20 along particular planes within a thickness T of tire patch 15, which is generally shown in FIGS. 3-7. Such circuitous arrangements generally result in undulations 33 along reinforcements 20. Variable-elevation arrangements may also be achieved by placing substantially entire reinforcements 20 at different elevations, which is generally shown in FIGS. 8, 9, 11, and 12. Further, variable-elevation arrangements may also be achieved by positioning reinforcements 20 having different thicknesses or diameters along a common central axis, so that one or more portions of the reinforcement having larger diameter or thickness are located within in a different plane, which results in an arrangement of reinforcements 20 that extend at different elevations (i.e., by an offset distance Δ) between the patch bottom surface 26 and/or the damaged area 30. It is acknowledged and understood that other arrangements of achieving an arrangement of reinforcements positioned at different elevations exist and are within the spirit and scope of this invention. The embodiments discussed above will be discussed more fully below. It is contemplated that the variable-elevation arrangement may be a patterned arrangement, as generally shown in the FIGURES, or may comprise any arbitrary arrangement. In operation, in particular embodiments, a patch 15 having an alternating arrangement of reinforcements 20 is applied to a damaged tire portion 30. In more particular embodiments, the arrangement of reinforcements is positioned adjacent a damaged portion 30, and/or an edge 32 of the damaged portion 30. This is generally shown, in one embodiment, in FIG. 1, and more specifically in FIGS. 3, 5, 6, and 8.

It is contemplated that reinforcements 20 may comprise any material known in the art, which includes cables formed of metal, such as steel, and/or cords formed of any textile, such as aramid, polyester, nylon, or rayon. The reinforcements 20 may extend any length, in any direction relative to patch ends 28, 29, and be spaced apart at any desired interval. In particular embodiments, as shown in the FIGURES, reinforcements 20 extend lengthwise between patch ends 28, 29, and are arranged laterally juxtaposed to each other in a parallel arrangement. It is contemplated that reinforcements may be arranged in any other desirable arrangements, which includes non-parallel arrangements.

It is understood that tire patch 15 having an arrangement of multi-elevation reinforcements 20 may be formed and constructed according to any method and manner known in the art. In general, tire patch 15 may be formed from one or more layers of material, at least one of which includes a plurality of reinforcements 20. With reference to FIG. 2, particular embodiments of tire patch 15 include a top cushion layer 16a, a reinforcement layer 16b, and a bottom cushion layer 16c. More generally, patch 15 may comprise a patch body 21, which may be formed of layers 16a and 16c. Patch body 21, and more specifically the layers of material, envelope one or more reinforcements 20 positioned within the patch body 21. Patch body 21 is generally comprised of rubber, which may be cured or uncured. However, it will be understood by persons of ordinary skill in the art that other polymers, and more specifically elastomeric material, can be used to construct the patch body 21. It is contemplated that additional reinforcement layers 16b, and top and/or bottom layers 16a, 16c may not exist. It is also contemplated that patch 15 may also include an attachment layer for attaching patch 15 to a tire. Attachment layer may comprise an uncured layer of rubber, and a layer of adhesive, which may comprise any adhesive or chemical known in the art adapted for bonding the tire patch 15 to the rubber tire 10.

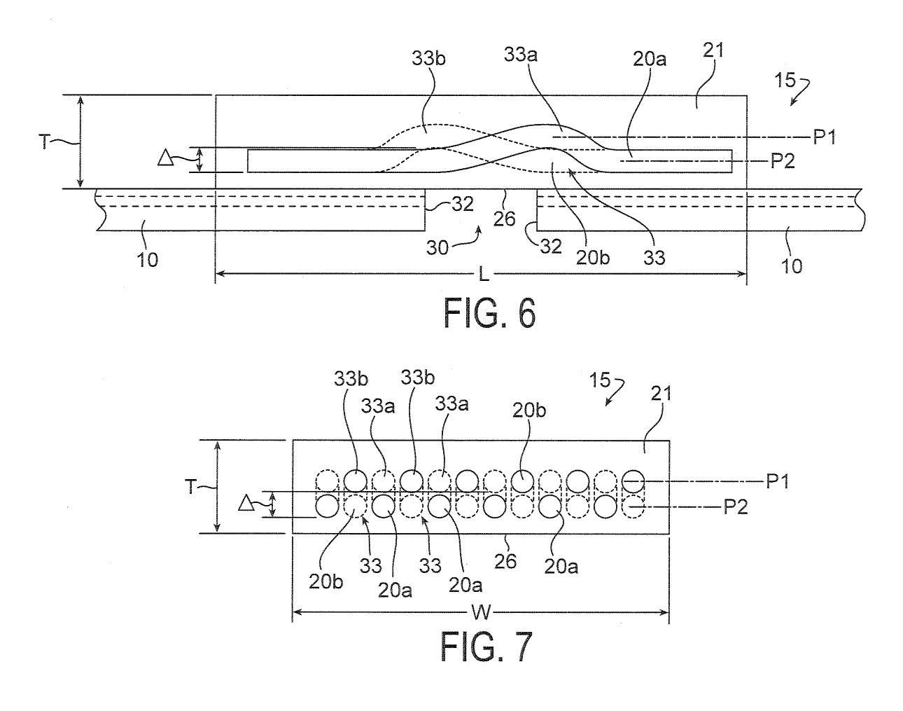

Referring now to FIGS. 3-7, several reinforcements 20 may be arranged at various elevations circuitously within a thickness T of the patch 15. Circuitous arrangement refers to the non-linear or curvilinear path that a reinforcement 20 follows while extending through different heights or thicknesses within thickness T of patch 15. Stated another way, portions of particular reinforcements 20 extend in a plane that extends longitudinally and laterally at a desired height or thickness within patch thickness T. Accordingly, reinforcement 20 may be fashioned with one or more undulations 33 extending between two (2) or more elevations within patch thickness T. It is contemplated that an undulation 33 may comprise a reinforcement extending from a plane or elevation to a second plane or elevation. Subsequently, the reinforcement may extend: (1) back into the first plane or elevation as generally shown in FIGS. 3-7, (2) into a third plane or elevation; or, (3) continue to extend along the second plane or elevation through the end of such reinforcement, which, in other words, provides one change in elevation along the length of a reinforcement. The embodiments showing undulations 33 in the FIGURES only show reinforcements having two (2) changes in direction (one change occurring when extending into the undulation 33, and the other when returning from the undulation 33). The length and height of the undulations 33 may vary as desired. FIGS. 3 and 5 show generally longer undulations, while FIG. 6 shows relatively shorter undulations. For purposes of discussion, a longitudinal axis X is identified as traversing lengthwise through the patch body 21. Similarly, a transverse axis Y defines a direction perpendicular to the X-axis thereby traversing orthogonally through the thickness T of the patch body 21. Accordingly, the one or more undulations 33 are formed by a reinforcement translating one or more directions along the Y-axis (along the patch thickness T). Although the embodiments shown in the FIGURES do not translate laterally, it is contemplated that undulations 33 and reinforcements 20 may translate laterally as well as in a Y-axis direction. It is noted that in the present embodiment, there is no lateral movement of the undulations 33 through the width of the patch body 21. Although, it will be appreciated that the undulations may follow any circuitous route within the patch body 21.

With further reference to FIGS. 3-7, the variable-elevation arrangement of reinforcements 20 includes an alternating or staggered arrangement of undulations 33. More specifically, it provides a plurality of alternating or staggered pairs of reinforcements 20a, 20b that together provide an alternating arrangement of reinforcements 20. Each undulation 33 occurs at a particular location within patch thickness T, or, in other words, within different planes. Any arrangement of alternating or staggered reinforcements 20 is contemplated, which may be achieved by any arrangement of undulations 33. As shown in FIGS. 4 and 7, in particular embodiments, the arrangement of undulations 33 generally alternates between adjacent reinforcements 20 to form a 1×1 series of undulating reinforcements 20a, 20b at particular (spaced or adjacent) locations along patch length L. In FIGS. 3-4, the 1×1 series includes one reinforcement 20a that undulates (see 33a along plane P1), while the adjacent reinforcement 20b does not undulate along plane P2. In FIG. 5, the 1×1 series includes one (1) reinforcement 20a that undulates upwards (see 33a along plane P1), while the adjacent reinforcement 20b undulates downwardly (see 33b along plane P2). In FIGS. 6-7, the 1×1 series comprises one reinforcement 20a that undulates at a particular location along patch length L (see 33a along plane P1), while the adjacent reinforcement 20b undulates at a different location along patch length L (see 33b along plane P2). Still, it is contemplated that undulations 33 may occur at other intervals between reinforcements 20, such as, for example, 1×2, 2×2, or 1×3 series, or at arbitrary intervals. In one embodiment, a 1×2 arrangement is shown in FIG. 12. It is also contemplated that undulations 33 occurring within a plurality of reinforcements 20 may occur at 2 or more elevations. For example, the embodiment shown in FIG. 5 has undulations that occur along two different elevations (locations) within patch thickness T, or, in other words, within two different planes P1 and P2. In an embodiment represented by FIG. 11, undulations 33 may occur at three different elevations within thickness T or within three planes P1, P2, and P3. It is also contemplated each reinforcement 20 may include more than one undulation 33.

Undulations 33 may occur at different longitudinal locations along different reinforcements 20, generally shown in one embodiment in FIG. 7, or along the same or similar longitudinal locations, generally shown in FIGS. 3-5. Undulations 33 may be centered within the tire patch 15, as generally shown in FIGS. 3-5, or positioned along any portion of patch length L, which is shown in an exemplary embodiment in FIGS. 6-7. When applied to the tire, patch 15 is applied to the tire so that one or more undulations 33 are positioned adjacent the damaged area 30. In particular embodiments, the one or more undulations 33 are positioned adjacent an edge 32 of damaged portion 30, as shown by example in FIGS. 3 and 6.

In other embodiments, variable-elevation reinforcement arrangements may be achieved by offsetting reinforcements vertically within patch thickness T. With general reference to an exemplary embodiment shown in FIGS. 8 and 9, the patch body 21 includes adjacent, alternating pairs of reinforcements 20a, 20b, each extending within different planes P1 and P2. Accordingly, each reinforcement 20a, 20b is located at a different distance or elevation from bottom surface 26 or damaged area 30, the difference being represented by offset distance Δ. Planes P1 and P2, as well as any other plane P, extend through the patch body 21 in the longitudinal direction. In the particular embodiment shown, planes P1, P2 are parallel to each other, but each may also be parallel to the top and/or bottom surface 26 of tire patch 15. Further, planes, such as, for example, planes P1 and P2, may be angled relative to other planes and/or planes that extend in a curvilinear path.

While FIG. 9 shows an arrangement of reinforcements 20 that alternate between adjacent reinforcements 20 between different elevations within thickness T. More specifically, FIG. 9 represents a 1×1 series forming a variable-elevation arrangement of alternating pairs of reinforcements 20a, 20b. As mentioned above, other series are contemplated, such as 2×2, 2×1, 1×1×1, and 1×1×1×1. For example, FIG. 12 which shows a 2×1 arrangement of 20a-20a-20b. Further, FIG. 11 provides a 1×1×1×1 arrangement of 20a-20b-20c-20b. Other arrangements, such as arbitrary arrangements, are also contemplated. Arbitrary arrangements generally do not comprise a repeatable pattern or arrangement. Accordingly, two or more elevations or planes may be spanned by portions of reinforcements 20. With the exception of FIG. 11, FIGS. 3-12 show two elevations or planes. It is contemplated that more than two (2) elevations may be spanned by reinforcements 20, namely, reinforcements 20a and 20b. For example, three (3) elevations are included in the arrangement shown in FIG. 11, which are spanned by reinforcements 20a, 20b, and 20c. Any number of elevations or planes may be referenced for illustrating the position of the reinforcements 20. Planes P1 through P3 may be equidistantly spaced apart. Alternatively, the distance between one set of planes may be greater than another set of planes. The references planes may include equal quantities of reinforcements 20, although the tire patch 15 may have different quantities of reinforcements 20 in each plane. All such variations are to be construed as falling within the scope of the coverage of the embodiments of the present invention.

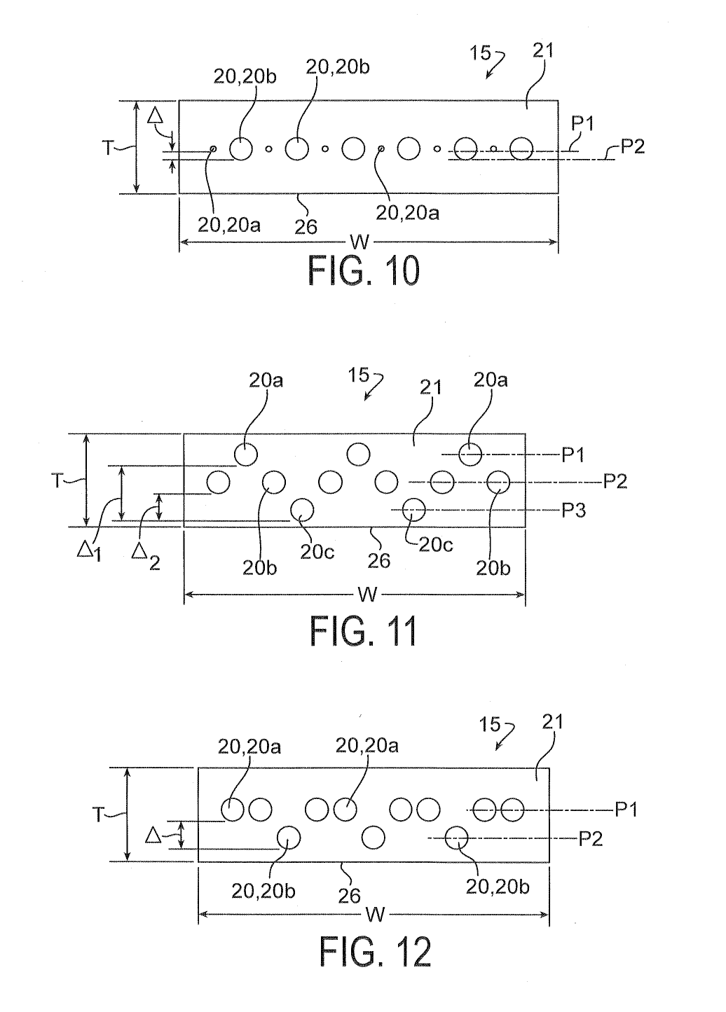

Other embodiments of the present invention incorporate reinforcements 20 having different diameters. FIG. 10 shows one particular embodiment wherein the diameter of one reinforcement 20a is substantially smaller than another reinforcement 20b, which may be adjacently positioned. Any difference in diameter reinforcements may be selected for use in the tire patch 15 without deviating from the intended scope of coverage of the embodiment of the present invention. FIG. 10 shows one arrangement of reinforcements 20 alternating between different elevations by virtue of each reinforcement's cross-sectional size, which, in the present embodiment, is defined by different diameters. Accordingly, each reinforcement 20a, 20b extends, or is positioned, in a different elevation (denoted by Δ) or plane P1, P2, respectively. Still, any order of positioning differently sized reinforcements 20 may be chosen without departing from the intended scope of coverage of the embodiments of the subject invention.

In forming the embodiments shown in FIGS. 8-12, it is contemplated that reinforcements 20 positioned at varying elevations may be formed collectively within one (1) reinforcement layer 16b. It is also contemplated, in particular embodiments, that a variable-elevation arrangement of reinforcements may be formed from multiple reinforcement layer plies or sheets, where each ply or sheet is associated with reinforcements 20 for placement at a particular elevation. For example, with reference to FIG. 9, reinforcement layer 16b is formed of a first layer associated with reinforcements 20a and a second layer associated with reinforcements 20b. When forming arrangements having undulations 33, in particular embodiments, it is contemplated that a portion of rubber 24 may be placed in association with undulating portions, such as to fill the cavity between variable elevation reinforcements 20a, 20b, and/or to form undulations 33 during the manufacturing process.

While this invention has been described with reference to particular embodiments thereof, it shall be understood that such description is by way of illustration and not by way of limitation. Accordingly, the scope and content of the invention are to be defined only by the terms of the appended claims.

1. A tire patch for repairing a tire, the patch comprising:
a patch body being defined by a thickness; and,
a plurality of non-woven reinforcements having a length and positioned at least partially within the patch body in a spaced-apart, side-by-side arrangement, where at least a portion of the plurality of reinforcements are arranged to laterally vary between two or more elevations within the patch thickness.

2. The tire patch of claim 1, wherein the arrangement of laterally varying reinforcements includes one or more reinforcements that are routed circuitously within the patch thickness between two or more elevations respective of the patch thickness, wherein a portion of the one or more circuitously routed reinforcements is offset a distance along the patch thickness relative to an adjacent portion of an adjacent reinforcement.

3. The tire patch of claim 1, wherein the arrangement of laterally varying reinforcements includes one or more reinforcements having an undulation that is offset a distance along the patch thickness relative to an adjacent portion of an adjacent reinforcement.

4. The tire patch of claim 1, wherein the arrangement of laterally varying reinforcements includes two or more reinforcements having an undulation, the undulations being arranged to form at least a portion of the laterally varying portion of reinforcements.

5. The tire patch of claim 4, wherein adjacent undulations of adjacent reinforcements extend in opposite directions relative to a longitudinal axis of any corresponding reinforcement.

6. The tire patch of claim 1, wherein the arrangement of laterally varying reinforcements includes a plurality of undulations staggered in a lengthwise direction of at least one of the reinforcements.

7. The tire patch of claim 1, wherein at least one of the reinforcements associated with the laterally varying reinforcement arrangement substantially extends within one of the two or more elevations.

8. The tire patch of claim 1, wherein at least one of the reinforcements associated with the laterally varying reinforcement arrangement is defined by a first diameter, and at least one of the reinforcements associated with the laterally varying reinforcement arrangement is defined by a second diameter, the first diameter being dissimilar to the second diameter.

9. The tire patch of claim 1, wherein two or more adjacent, non-staggered reinforcements that extend along the same elevation are interposed within the varying arrangement of reinforcements.

10. (canceled)

11. (canceled)

12. A tire patch containing non-woven reinforcements for repairing a tire, the patch comprising:
a patch body being defined by a thickness; and,
two or more pairs of adjacently staggered first and second reinforcements extending along the patch body, each first reinforcement having a portion positioned adjacent to a portion of the second reinforcement, the first reinforcement portion and the second reinforcement portion positioned at dissimilar elevations respective of the patch thickness.

13. The tire patch of claim 12, wherein each of the first reinforcements are substantially positioned along the same elevation.

14. The tire patch of claim 13, wherein each of the second reinforcements are substantially positioned along the same elevation.

15. The tire patch of claim 14, wherein the any of the first or second reinforcements are circuitously routed between any of two or more elevations.

16. (canceled)

17. The tire patch of claim 12, wherein the first reinforcement portion is defined by a first diameter and the second reinforcement portion is defined by a second diameter, the first diameter and the second diameter being dissimilar.

18. (canceled)

19. (canceled)

20. The tire patch of claim 12, wherein the two or more pairs of reinforcements extend in a substantially parallel lengthwise arrangement.

21. The tire patch of claim 12, wherein two or more adjacent, non-staggered reinforcements that extend along the same elevation are interposed within the alternating arrangement or reinforcements.

22. (canceled)

23. A method of repairing a damaged area of an associated vehicle tire, the method comprising the steps of:
providing a tire patch having: a patch body being defined by a thickness; and, a plurality of non-woven reinforcements having a length and positioned at least partially within the patch body in a spaced-apart, side-by-side arrangement, where at least a portion of the plurality of reinforcements are arranged to laterally vary between two or more elevations respective of the patch thickness; and,
attaching the tire patch to a portion of the tire to substantially cover the damaged area of the tire, wherein the portion of laterally alternating reinforcements is positioned in close relation to the damaged area of the tire.

24. (canceled)

25. The method of claim 23, wherein the step of attaching includes positioning the portion of laterally alternating reinforcements substantially adjacent to an edge of the damaged area of the tire.

26. The method of claim 25, wherein the edge includes at least one tire reinforcement ending.

27. The method of claim 23, wherein the step of attaching includes arranging a lengthwise direction of at least one the plurality of reinforcements in a generally radial direction of a radial tire.

28.-30. (canceled)
